(19) United States
(12) Patent Application Publication
(10) Pub. No.: US 2022/0329454 A1
(43) Pub. Date: Oct. 13, 2022

(54) TAGGING HOME NETWORK DEVICES BASED ON USER ACTIVITY

(71) Applicant: ARRIS Enterprises LLC, Suwanee, GA (US)

(72) Inventor: Sundar Murthy Tumuluru, Bangalore (IN)

(21) Appl. No.: 17/689,177

(22) Filed: Mar. 8, 2022

Related U.S. Application Data
(60) Provisional application No. 63/173,636, filed on Apr. 12, 2021.

(51) Int. Cl. H04L 12/28; H04W 4/02; H04W 4/30; H04W 24/10

(52) U.S. Cl. CPC H04L 12/282; H04W 4/02; H04W 4/30; H04W 24/10; H04L 2012/2841; H04L 2012/2849; H04L 2012/285

(57) ABSTRACT

A network controller for use with a person, a first and second network device, an external network, and a client device, first and second network device being configured to transmit first and second wireless signals respectively, network controller comprising: a memory, having stored therein, a data structure associating the person with a first location and time of day and associating the person with a second location and time of day; and a processor configured to execute instructions stored on memory to cause network controller to: monitor first and second wireless signals; determine a change in one of first and second wireless signals; tag first network device to first location based on the determined change in first wireless signals at first time of day; and tag second network device to second location based on the determined change in second wireless signals at second time of day.

### BACKGROUND

Embodiments of the invention relate to Wi-Fi communication networks.

### SUMMARY

Aspects of the present disclosure are drawn to a network controller for use with a person, a first network device, a second network device, an external network, and a client device, the first network device being configured to transmit first wireless signals, the second network device being configured to transmit second wireless signals, the network controller comprising: a memory, having stored therein, a data structure associating the person with a first location and first a time of day and associating the person with a second location and a second time of day; and a processor configured to execute instructions stored on said memory to cause said network controller to: monitor the first wireless signals over a first period; monitor the second wireless signals over a second period; determine a change in one of the first wireless signals and the second wireless signals; tag the first network device to the first location based on the determined change in the first wireless signals at the first time of day; and tag the second network device to the second location based on the determined change in the second wireless signals at the second time of day.

In some embodiments, the processor is further configured to execute instructions stored on the memory to additionally cause the network controller to create the data structure by: monitoring the first wireless signals monitored prior to the first period; determining a previous number of changes in the first wireless signals monitored prior to the first period; generating a first association of the first network device to the first location based on a first respective set of previous times of day for the determined previous number of changes in the first wireless signals monitored prior to the first period; monitoring the second wireless signals prior to the second period; determining a previous number of changes in the second wireless signals monitored prior to the second period; generate a second association of the second network device to the second location based on a second respective previous times of day for the determined previous number of changes in the second wireless signals monitored prior to the second period; and create the data structure based on the generated first association and the generated second association.

In some embodiments, the processor is configured to execute instructions stored on the memory to additionally cause the network controller to: further monitor the first wireless signals; further monitor the second wireless signals; determine a change in one of the further monitored first wireless signals and the further monitored second wireless signals; and automatically transmit an update signal to the client device based on at least one of the group consisting of: a change in a received signal strength indicator (RSSI) value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

Other aspects of the present disclosure are drawn to a method of using a network controller with a person, a first network device, a second network device, an external network, and a client device, the first network device being configured to transmit first wireless signals, the second network device being configured to transmit second wireless signals, said method including: monitoring, via a processor configured to execute instructions stored on the memory having stored therein, a data structure associating the person with a first location and first a time of day and associating the person with a second location and a second time of day, the first wireless signals over a first period; monitoring, via the processor, the second wireless signals over a second period; determining, via the processor, a change in one of the first wireless signals and the second wireless signals; tagging, via the processor, the first network device to the first location based on the determined change in the first wireless signals at the first time of day; and tagging, via the processor, the second network device to the second location based on the determined change in the second wireless signals at the second time of day.

In some embodiments, the method further includes monitoring, via the processor, the first wireless signals prior to the first period; determining, via the processor, a previous number of changes in the first wireless signals monitored prior to the first period; generating, via the processor, a first association of the first network device to the first location based on a first respective set of previous times of day for the determined previous number of changes in the first wireless signals monitored prior to the first period; monitoring, via the processor, the second wireless signals prior to the second period; determining, via the processor, a previous number of changes in the second wireless signals monitored prior to the second period; generating, via the processor, a second association of the second network device to the second location based on a second respective previous times of day for the determined previous number of changes in the second wireless signals monitored prior to the second period; and creating, via the processor, the data structure based on the generated first association and the generated second association.

In some embodiments, the determining a change in one of the first wireless signals and the second wireless signals includes determining the change in one of the first wireless signals and the second wireless signals based on at least one of the group consisting of: a change in an RSSI value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

In some embodiments, the method includes further monitoring, via the processor, the first wireless signals; further monitoring, via the processor, the second wireless signals; determining, via the processor, a change in one of the further monitored first wireless signals and the further monitored second wireless signals; and automatically transmitting, via the processor, an update signal to the client device based on one of a lack of change in the further monitored first wireless signals at the first time of day and a lack of change in the further monitored second wireless signals at the second time of day.

Other aspects of the present disclosure are drawn to a non-transitory, computer-readable media having computer-readable instructions stored thereon, the computer-readable instructions being capable of being read by a network controller for use with a person, a first network device, a second network device, an external network, and a client device, the first network device being configured to transmit first wireless signals, the second network device being configured to transmit second wireless signals, wherein the computer-readable instructions are capable of instructing the network controller to perform the method including: monitoring, via a processor configured to execute instructions stored on the memory having stored therein, a data structure associating the person with a first location and first a time of day and associating the person with a second location and a second time of day, the first wireless signals over a first period; monitoring, via the processor, the second wireless signals over a second period; determining, via the processor, a change in one of the first wireless signals and the second wireless signals; tagging, via the processor, the first network device to the first location based on the determined change in the first wireless signals at the first time of day; and tagging, via the processor, the second network device to the second location based on the determined change in the second wireless signals at the second time of day.

In some embodiments, the computer-readable instructions are capable of instructing the external server to perform the method further including: monitoring, via the processor, the first wireless signals prior to the first period; determining, via the processor, a previous number of changes in the first wireless signals monitored prior to the first period; generating, via the processor, a first association of the first network device to the first location based on a first respective set of previous times of day for the determined previous number of changes in the first wireless signals monitored prior to the first period; monitoring, via the processor, the second wireless signals over a second period; determining, via the processor, a previous number of changes in the previously monitored second wireless signals; generating, via the processor, a second association of the second network device to the second location based on a second respective previous times of day for the determined previous number of changes in the first wireless signals monitored prior to the first period; and creating, via the processor, the data structure based on the generated first association and the generated second association.

In some embodiments, the computer-readable instructions are further capable of instructing the external server to perform the method wherein the determining a change in one of the first wireless signals and the second wireless signals comprises determining the change in one of the first wireless signals and the second wireless signals based at least one of the group consisting of: a change in an RSSI value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

In some embodiments, the computer-readable instructions are capable of instructing the external server to perform the method further including: further monitoring, via the processor, the first wireless signals; further monitoring, via the processor, the second wireless signals; determining, via the processor, a change in one of the further monitored first wireless signals and the further monitored second wireless signals; and automatically transmitting, via the processor, an update signal to the client device based on one of a lack of change in the further monitored first wireless signals at the first time of day and a lack of change in the further monitored second wireless signals at the second time of day.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a method of tagging home network devices based on user activity;

FIG. 2 illustrates a communication network;

FIG. 3A illustrates an exploded view of a residence at a time to;

FIG. 3B illustrates an exploded view of a residence at a time t₁;

FIG. 3C illustrates an exploded view of a residence at a time t₂;

FIG. 3D illustrates an exploded view of a residence at a time t₃;

FIG. 3E illustrates an exploded view of a residence at a time t₄;

FIG. 4 illustrates an exploded view of a client device, a gateway device, and an external server;

FIG. 5 illustrates an exploded view of a residence within a communication network at a time t₅; and

FIG. 6 illustrates a topology of a residence.

### DETAILED DESCRIPTION

Current home networks may include, but are not limited to, gateway devices, Wi-Fi extenders, or stations. Further, some homes may include Wi-Fi sensing technology, which detects environmental changes in the home network by observing radio signals of connected devices. This technology is particularly useful in the homes of elderly people. An outside user can ensure that the elderly person's well-being is maintained by remotely observing the home network. However, many Wi-Fi sensing applications do not have the ability to know the exact location of connected devices in a household. This would be helpful information for the outside user in case there is abnormal behavior in the home network.

What is needed is a system and method for tagging home network devices based on user activity.

A system and method in accordance with the present disclosure tags home network devices based on user activity.

In accordance with the present disclosure, a home network controller (HNC) may inside the home network's gateway device, which will collect data from the connected devices. As Wi-Fi signals are sensitive to objects and obstacles, mobile obstacles such as pets or people appearing between the gateway device and connected devices will reduce the respective signal strength. Further, human bodies are around 60% water; even being near a connected device can alter the signal strength as the body absorbs some of the Wi-Fi signal. The HNC may additionally both analyze respective device data and manage home network configuration changes. By analyzing respective device data, the HNC will be able to determine user activity as well as predict future user activity. Further, the HNC will check for other environmental changes within the home network to adjust monitoring parameters. A user outside of the home network will receive notifications when there appears to be abnormal activity within the household.

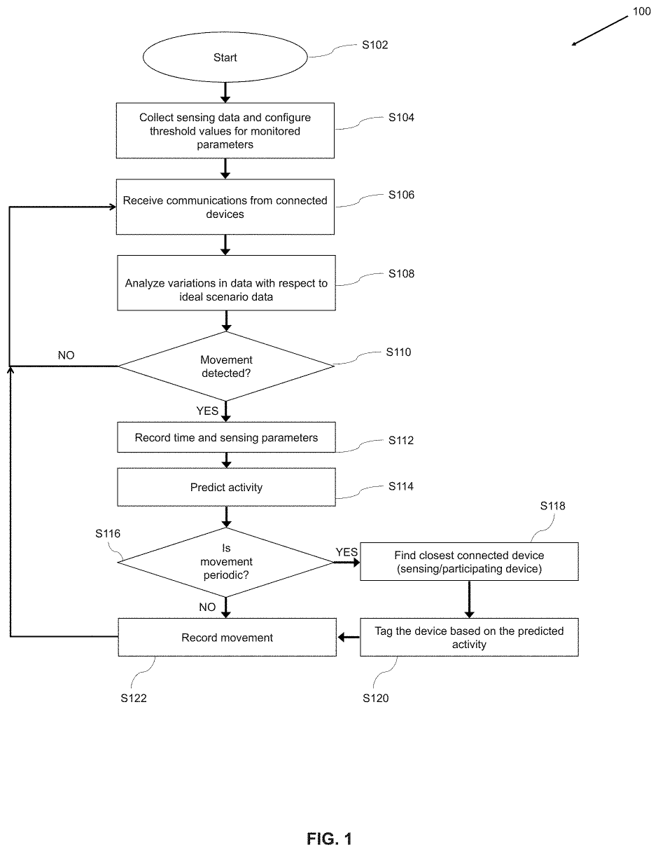

An example system and method for tagging home network devices based on user activity in accordance with aspects of the present disclosure will now be described in greater detail with reference to FIGS. 1-5.

FIG. 1 illustrates a method 100 of tagging home network devices based on user activity in accordance with aspects of the present disclosure.

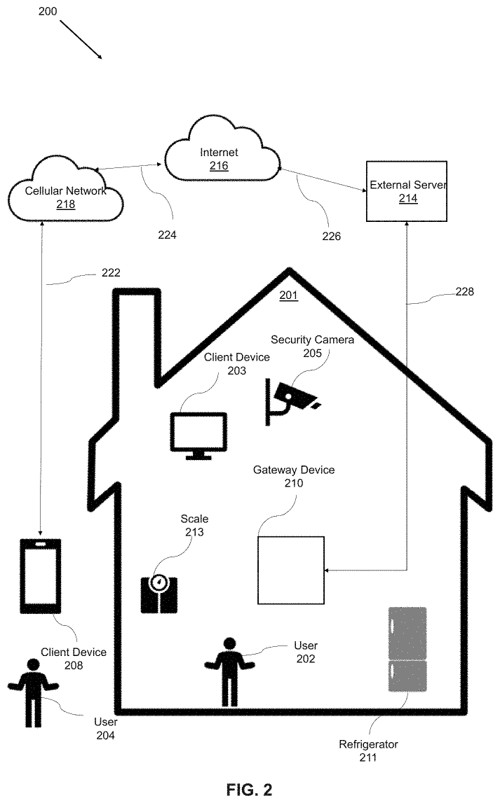

As shown in FIG. 1, method 100 starts (S102), and monitored parameters are collected and respective threshold values for the monitored parameters are configured (S104). This will be described in greater detail with reference to FIG. 2.

FIG. 2 illustrates a communication network 200, in accordance with aspects of the present disclosure.

As shown in FIG. 2, communication network 200 includes a residence 201, a user 202, a user 204, a client device 203, a client device 208, a security camera 205, a gateway device 210, a refrigerator 211, an external server 214, an internet 216, a cellular network 218, and communication channels 222, 224, 226, and 228.

As shown in FIG. 2, client device 203, security camera 205, refrigerator 211 and scale 213 are devices that connected to gateway device 210. These wirelessly communicate with gateway device 210, wherein predetermined parameters associated with each wireless communication are monitored by gateway device 210. Non-limiting examples of such monitored parameters of the wireless communications include at least one of the group consisting of: a change in an RSSI value each received wireless signal; a time stamp at which each wireless signal is received; a neighbor report within each wireless signal; a channel number of each wireless signal; a channel bandwidth of each wireless signal; a channel utilization of each wireless signal; channel state information each wireless signal; and combinations thereof.

Gateway device 210 analyzes the monitored parameters of all the received wireless signals. However, these monitored parameters will fluctuate based on activity in residence 201, a non-limiting example of which being user 202 walking in between a client device that is wirelessly transmitting signals and gateway device 210 that is receiving the wirelessly transmitted signals. Based on the fluctuation of the monitored parameters, and the times that the monitored parameters fluctuate, expected ranges for sensing parameters are assigned. As will be described in greater detail below, gateway 210 will generate a signature corresponding to all of the respective monitored parameters from each of the connected devices. Further, this signature will change based on the location of user 202 within residence 201.

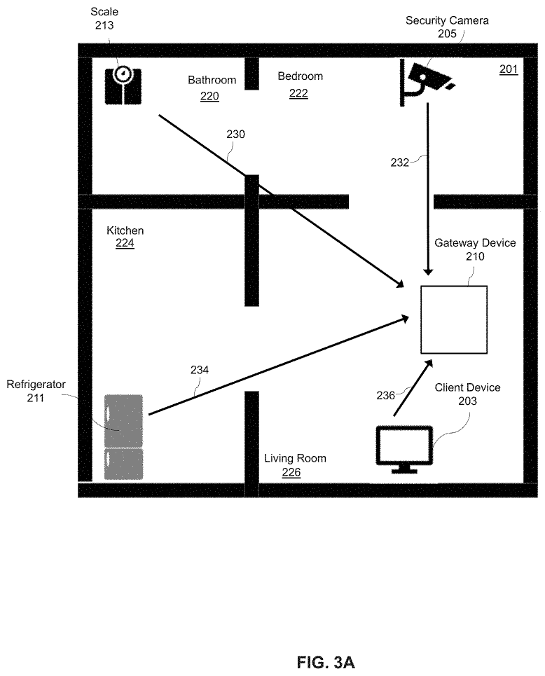

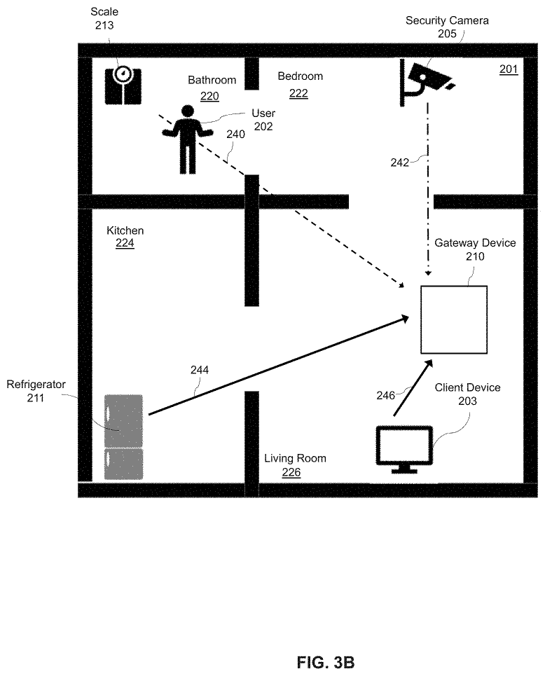

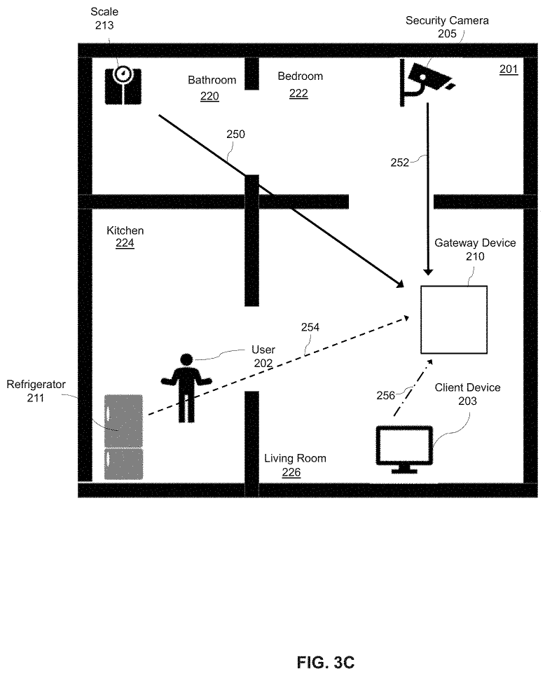

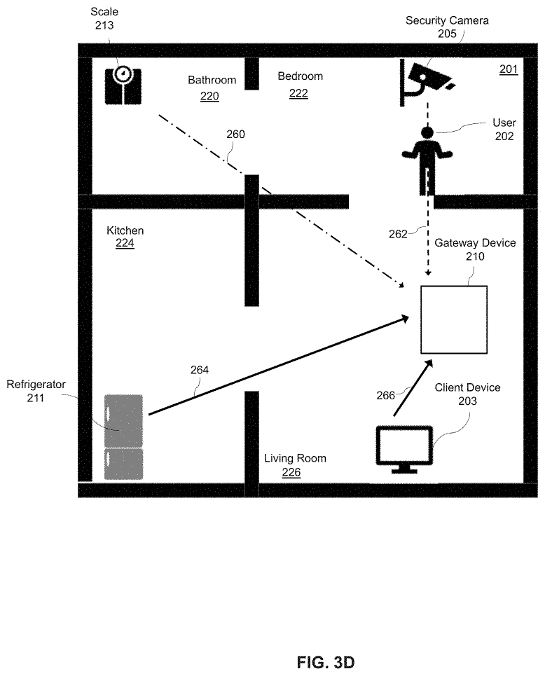

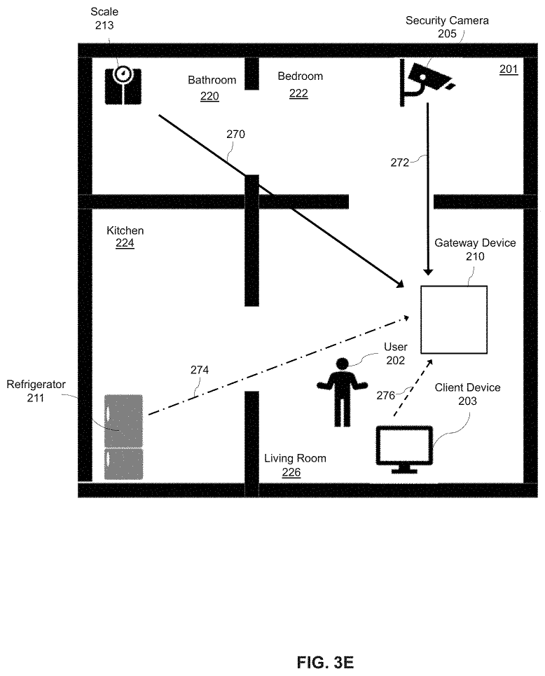

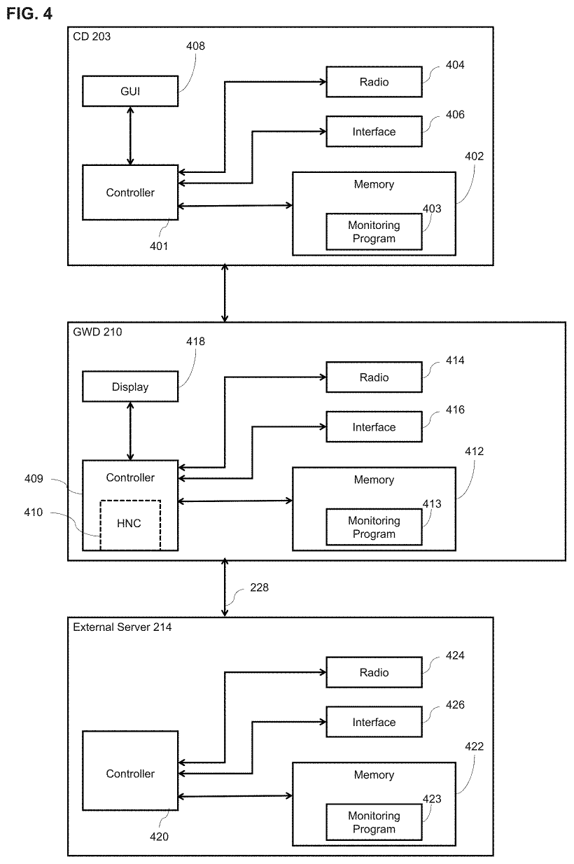

Returning to FIG. 1, after monitored parameters are collected and threshold values for sensing parameters are configured (S104), communications are received from connected devices (S106). This will be described in greater detail with reference to FIGS. 3A and 4.

FIG. 3A shows an exploded view of residence 201 at a time to, in accordance with aspects of the present disclosure.

As shown in FIG. 3A, residence 201 includes multiple rooms: a bathroom 220, a bedroom 222, a kitchen 224, and a living room 226. Each room is associated with a specific device: bathroom 220 includes scale 213; bedroom 222 includes security camera 205; kitchen 224 includes refrigerator 211; and living room 226 includes client device 203 and gateway device 210. In this example embodiments, each of scale 213, security camera 205, refrigerator 211, and client device 103 are configured to wirelessly communicate with gateway device 210, e.g., via a Wi-Fi protocol. For example, scale 213 transmits a wireless signal 230 to gateway device 210, security camera 205 transmits a wireless signal 232 to gateway device 210, refrigerator 211 transmits a wireless signal 234 to gateway device 210, and client device 203 transmits a wireless signal 236 to gateway device 210.

FIG. 4 shows an exploded view of client device 103, gateway device 210, and external server 214, in accordance with aspects of the present disclosure.

As shown in FIG. 4, client device 203 includes: a controller 401; a memory 402, which has stored therein a monitoring program 403; and at least one radio, a sample of which is illustrated as a radio 404; an interface 406 and a graphic user interface (GUI) 408.

In this example, controller 401, memory 402, radio 404, interface 406 and GUI 408 are illustrated as individual devices. However, in some embodiments, at least two of controller 401, memory 402, radio 404, interface 406 and GUI 408 may be combined as a unitary device. Further, in some embodiments, at least one of controller 401 and memory 402 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 401 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 203 in accordance with the embodiments described in the present disclosure.

Memory 402 can store various programming, and user content, and data, including monitoring program 403.

Radio 404 may include a WLAN interface radio transceiver that is operable to communicate with gateway device 210. Radio 404 includes one or more antennas and communicates wirelessly via one or more of the 2.4 GHz band, 5 GHz band, 6 GHz band, and 60 GHz band, or at the appropriate band and bandwidth to implement any IEEE 802.11 Wi-Fi protocols, such as the Wi-Fi 4, 5, 6, or 6E protocols. Radio 404 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 406 can include one or more connectors, such as RF connectors, or Ethernet connectors, and/or wireless communication circuitry, such as 5G circuitry and one or more antennas.

GUI 408 may be any known device or system to display an interactive image to a user, to enable the user to control operation of client device 203.

Gateway device 210 includes: a controller 409, which has stored therein a home network controller (HNC) 410; a memory 412, which has stored therein a monitoring program 413; and at least one radio, a sample of which is illustrated as a radio 414; an interface 416 and a display 418. Gateway device 201 is configured to create and maintain a wireless local area network (WLAN) to enable wireless communication with each of scale 213, security camera 205, refrigerator 211, and client device 103, e.g., via a Wi-Fi protocol

In this example, controller 409, memory 412, radio 414, and interface 416 are illustrated as individual devices. However, in some embodiments, at least two of controller 409, memory 412, radio 414, and interface 416 may be combined as a unitary device. Whether as individual devices or as combined devices, controller 409, memory 412, radio 414, and interface 416 may be implemented as any combination of an apparatus, a system and an integrated circuit. Further, in some embodiments, at least one of controller 409, memory 414 and interface 416 may be implemented as a computer having non-transitory computer-readable media for carrying or having computer-executable instructions or data structures stored thereon.

Controller 409 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the gateway device 210 in accordance with the embodiments described in the present disclosure.

HNC 410 controls gateway device 210 within the wireless network. HNC 410 may perform tasks such as steering client devices, such as a cell phone, from one access point to another.

It should be noted that an HNC may reside in any access point of communication network 200 as shown in FIG. 2, including but not limited to gateway device 210. HNC 410 is shown here in gateway device 210 as an example and merely for purposes of discussion.

Memory 412, as will be described in greater detail below, has instructions stored thereon that, when executed by controller 409, enables gateway device 210 to: monitor wireless signals from a first client device over a first period; monitor wireless signals from a second client device over a second period; determine a change in one of the first wireless signals and the second wireless signals; tag the first network device to a first location based on the determined change in the first wireless signals at a first time of day; and tag the second network device to a second location based on the determined change in the second wireless signals at a second time of day.

In some embodiments, memory 412 has further instructions stored thereon that when executed by controller 409 enable gateway device 210 to: monitor the first wireless signals prior to the first period; determine a previous number of changes in the first wireless signals monitored prior to the first period; generate a first association of the first network device to the first location based on a first respective set of previous times of day for a determined previous number of changes in the first wireless signals monitored prior to the first period; monitor the second wireless signals prior to the second period; determine a previous number of changes in the second wireless signals monitored prior to the second period; generate a second association of the second network device to the second location based on a second respective previous times of day for a determined previous number of changes in the second wireless signals monitored prior to the second period; and create a data structure based on the generated first association and the generated second association.

In some embodiments, memory 412 has further instructions stored thereon that when executed by controller 409 enable gateway device 210 to determine the change in one of the first wireless signals and the second wireless signals based on at least one of the group consisting of: a change in an RSSI value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

In some embodiments, memory 412 has further instructions stored thereon that when executed by controller 409 enable gateway device 210 to: further monitor the first wireless signals; further monitor the second wireless signals; determine a change in one of the further monitored first wireless signals and the further monitored second wireless signals; and automatically transmit an update signal to client device 208 based on one of a lack of change in the further monitored first wireless signals at the first time of day and a lack of change in the further monitored second wireless signals at the second time of day.

Radio 414 may also be referred to as a wireless communication circuit, such as a Wi-Fi WLAN interface radio transceiver and is operable to communicate with client device 203 and external server 214. Radio 408 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Gateway device 210 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands, RF4CE protocol, ZigBee protocol, Z-Wave protocol, or IEEE 802.15.4 protocol.

Interface 416 can include one or more connectors, such as RF connectors, or Ethernet connectors, and/or wireless communication circuitry, such as 5G circuitry and one or more antennas. Interface 416 receives content from external server 214 (as shown in FIGS. 2 and 4) by known methods, non-limiting examples of which include terrestrial antenna, satellite dish, wired cable, DSL, optical fibers, or 5G as discussed above. Through interface 416, gateway device 210 receives an input signal, including data and/or audio/video content, from external server 214 and can send data to external server 214.

External server 214 includes: a controller 420; a memory 422, which has stored therein a monitoring program 423; and at least one radio, a sample of which is illustrated as a radio 424; and an interface 426.

In this example, controller 420, memory 422, radio 424, and interface 426 are illustrated as individual devices. However, in some embodiments, at least two of controller 420, memory 422, radio 424, and interface 426 may be combined as a unitary device. Further, in some embodiments, at least one of controller 420 and memory 422 may be implemented as a computer having tangible computer-readable media for carrying or having computer-executable instructions or data structures stored thereon.

Controller 420 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of external server 214 in accordance with the embodiments described in the present disclosure.

Memory 422 can store various programming, and user content, and data, including monitoring program 423.

Radio 424 may include a WLAN interface radio transceiver that is operable to communicate with gateway device 210 as shown in FIGS. 3A-4. Radio 424 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. Radio 424 can also be equipped with a radio transceiver/wireless communication circuit to implement a wireless connection in accordance with any Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands or 60 GHz bands, RF4CE protocol, ZigBee protocol, Z-Wave protocol, or IEEE 802.15.4 protocol.

Interface 426 can include one or more connectors, such as RF connectors, or Ethernet connectors, and/or wireless communication circuitry, such as 5G circuitry and one or more antennas.

In operation, with reference to FIG. 4, client device 203 may transmit signals by way of radio 404 to radio 414 of gateway device 210. Security camera 205, refrigerator 211 and scale 213 will similarly transmit their respective signals to gateway device 210.

Returning to FIG. 1, after communications are received from connected devices (S106), monitored parameters are analyzed for variations (S108). For example, referring to FIG. 3A, gateway device 210 receives communications from client device 203, security camera 205, refrigerator 211 and scale 213. Each of these communications has respective parameters for which gateway device 210 may analyze, non-limiting examples of which include: an RSSI value; a time stamp at which the communication is received; a neighbor report within the communication; a channel number of the communication; a channel bandwidth of the communication; a channel utilization of the communication; a channel state information of the communication; and combinations thereof. Further, the analyzed values for any of these parameters may change as a result of the presence of user 202 being near or within the path of the communication. For example, as discussed above, human bodies are around 60% water; even being near a connected device can alter the signal strength as the body absorbs some of the Wi-Fi signal. Accordingly, an RSSI value of communications from a connected device may drastically change when user 202 is near or within the path of the communications.

Further, for each device, each of the parameters that gateway device 210 is monitoring has an ideal parameter range, which reflects the respective monitored parameter without interference from user 202. These ideal parameter values may be stored in memory 412. As gateway device 210 receives communications from each client device, gateway device may analyze the respective monitored parameters. For example, returning to FIG. 3A, gateway device 210 will analyze the respective monitored parameters of each of wireless signal 230, wireless signal 232, wireless signal 234, and wireless signal 236. In this example, as user 202 is not in residence 201, and therefore will not interfere with any of the communications, the respective monitored parameters of each of wireless signal 230, wireless signal 232, wireless signal 234, and wireless signal 236 will have ideal parameter values, which will be stored in memory 412.

For each monitored parameter, for each communication from each client device, gateway device 210 may then compare the parameter values with the respective ideal parameter values in memory 412. As such, gateway device 210 may then determine whether each communication is within its respective respective ideal data parameter range, thus indicating that the communication is without interference from user 202. This would therefore indicate that user 202 is not near or within the path of the communication.

However, gateway device 210 will additionally be able to determine, not only whether user 202 is in residence 201, but where user 202 is in residence 201. This will be described in greater detail with reference to FIGS. 3B-E.

FIG. 3B shows an exploded view of residence 201 at a time t₁, in accordance with aspects of the present disclosure. User 202 is now inside bathroom 220 of residence 202.

For purposes of discussion, suppose that when user 202 is in bathroom 220 of residence 201, scale 213 transmits a wireless signal 240 to gateway device 210, security camera 205 transmits a wireless signal 242 to gateway device 210, refrigerator 211 transmits a wireless signal 244 to gateway device 210, and client device 203 transmits a wireless signal 246 to gateway device 210. In this example, because user 202 is in bathroom 220, wireless signal 240 will have different parameter values as compared to wireless signal 230 of FIG. 3A. Further, the location of user 202 in the vicinity of security camera 205 will result in wireless signal 242 having different parameter values as compared to wireless signal 232 of FIG. 3A. The location of user 202 may or may not affect the parameters of wireless signals from refrigerator 211 and client device 203. However, for this example let wireless signal 244 from refrigerator 211 have different parameter values as compared to wireless signal 234 from refrigerator 211 of FIG. 3A and let wireless signal 246 from client device 203 have different parameter values as compared to wireless signal 236 from client device 203 of FIG. 3A.

In any event, gateway device 210 may generate a signature based on the received communications, wherein the signature is associated with user 202 being located at specific locations within residence 101. For example, as shown in FIG. 4, in some embodiments, HNC 410 may execute instructions in monitoring program 413 to cause HNC to generate a signature based on the monitored parameters of any of communication 240, communication 242, communication 244, and communication 246, and combinations thereof. In some embodiments, HNC 410 may execute instructions in monitoring program 413 to cause HNC to additionally process any of communication 240, communication 242, communication 244, and communication 246 and combinations thereof to generate such a signature. Non-limiting examples of further processes include averaging, adding, subtracting, and transforming any of communication 240, communication 242, communication 244, and communication 246 and combinations thereof. This signature may be stored in memory 412 in a data structure that associates the signature with the user 202 being in bathroom 220.

FIG. 3C shows an exploded view of residence 201 at a time t₂, in accordance with aspects of the present disclosure. In this example, user 202 is now inside kitchen 224.

For purposes of discussion, suppose that when user 202 is in kitchen 224, refrigerator 211 transmits a wireless signal 254 to gateway device 210, security camera 205 transmits a wireless signal 252 to gateway device 210, scale 213 transmits a wireless signal 250 to gateway device 210, and client device 203 transmits a wireless signal 256 to gateway device 210. In this example, because user 202 is in kitchen 224, wireless signal 254 will have different parameter values as compared to wireless signal 234 of FIG. 3A. Further, the location of user 202 in the vicinity of client device 203 will result in wireless signal 256 having different parameter values as compared to wireless signal 236 of FIG. 3A. The location of user 202 may or may not affect the parameters of wireless signals from scale 213 and security camera 205. However, for this example let wireless signal 250 from scale 213 have different parameter values as compared to wireless signal 230 from scale 213 of FIG. 3A and let wireless signal 252 from security camera 205 have different parameter values as compared to wireless signal 232 from security camera 205 of FIG. 3A.

In any event, gateway device 210 may generate another signature based on the received communications. This signature may be stored in memory 412 and be associated with the user 202 being in kitchen 224.

FIG. 3D shows an exploded view of residence 201 at a time t₃, in accordance with aspects of the present disclosure. In this example, user 202 is now inside bedroom 222.

For purposes of discussion, suppose that when user 202 is in bedroom 222, security camera 205 transmits a wireless signal 262 to gateway device 210, scale 213 transmits a wireless signal 260 to gateway device 210, refrigerator 211 transmits a wireless signal 264 to gateway device 210, and client device 203 transmits a wireless signal 266 to gateway device 210. In this example, because user 202 is in bedroom 222, wireless signal 262 will have different parameter values as compared to wireless signal 232 of FIG. 3A. Further, the location of user 202 in the vicinity of scale 213 will result in wireless signal 260 having different parameter values as compared to wireless signal 230 of FIG. 3A. The location of user 202 may or may not affect the parameters of wireless signals from refrigerator 211 and client device 203. However, for this example let wireless signal 264 from refrigerator 211 have different parameter values as compared to wireless signal 234 from refrigerator 212 of FIG. 3A and let wireless signal 266 from client device 203 have different parameter values as compared to wireless signal 236 from client device 203 of FIG. 3A.

In any event, gateway device 210 may generate another signature based on the received communications. This signature may be stored in memory 412 and be associated with the user 202 being in bedroom 222.

FIG. 3E shows an exploded view of residence 201 at a time t₄, in accordance with aspects of the present disclosure. In this example, user 202 is now inside living room 226.

For purposes of discussion, suppose that when user 202 is in living room 226, client device 203 transmits a wireless signal 276 to gateway device 210, scale 213 transmits a wireless signal 270 to gateway device 210, refrigerator 211 transmits a wireless signal 274 to gateway device 210, and security camera 205 transmits a wireless signal 272 to gateway device 210. In this example, because user 202 is in living room 226, wireless signal 276 will have different parameter values as compared to wireless signal 236 of FIG. 3A. Further, the location of user 202 in the vicinity of refrigerator 211 will result in wireless signal 274 having different parameter values as compared to wireless signal 234 of FIG. 3A. The location of user 202 may or may not affect the parameters of wireless signals from scale 213 and security camera 205. However, for this example let wireless signal 270 from scale 213 have different parameter values as compared to wireless signal 230 from scale 213 of FIG. 3A and let wireless signal 272 from security camera 205 have different parameter values as compared to wireless signal 232 from security camera 205 of FIG. 3A.

In any event, gateway device 210 may generate another signature based on the received communications. This signature may be stored in memory 412 and be associated with the user 202 being in living room 226.

It should be noted that gateway device 210, in a supervised machine learning phase using any known machine learning algorithm, may generate and store many different signatures to associate user 202 with the many locations within residence 201.

Returning to FIG. 1, after monitored parameters are analyzed for variations (S108), it is determined whether movement has been detected (S110).

Returning to FIG. 1, if it is determined that movement has not been detected (N at S110), then communications are once again received from the connected devices (Return to S106). For example, presume that user 202 has remained in living room 226 for a period of time. In such a case, gateway device 210 will continue to generate signatures based on the location of user 202. Further, theses signatures will generally be the same, as the user remains within living room 226.

Still further, as shown in FIG. 4, HNC 410 may compare the newly generated signatures with signatures previously stored in memory 412 in accordance with any known machine learning algorithm. The signatures within memory 412 that are associated with user 202 being in living room 226, for example as discussed above with reference to FIG. 3E, will correspond to the newly generated signatures. In such a case, HNC 410 will determine that user 202 is located in living room 226. Client device 203, security camera 205, refrigerator 211 and scale 213 will continue to send respective monitored parameters to gateway device 210.

Returning to FIG. 1, if it is determined that movement has been detected (Y at S110), then the time and parameters are recorded (S112). For example, for purposes of discussion, suppose that user 202 is in living room 226 in a manner similar to that discussed above with reference to FIG. 3E. Then, user 202 walks to and stays in bathroom 220 in a manner similar to that as shown in FIG. 3B. In such a case, gateway device 210 recognize a change in the initial signature, associated with user 202 being in living room 226 in a manner similar to that discussed above with reference to FIG. 3E, to that of the subsequent signature, associated with user 202 being in bathroom 220 in a manner similar to that as shown in FIG. 3B. This drastic change in signatures will indicate movement of user 202 throughout residence 201.

Therefore, it should be noted that during a learning process, as user 202 moves throughout residence 201, for example as shown in the remaining FIGS. 3C-E, controller 409 will generate a plurality of different signatures, respectively, associated with user 202 in residence 201. Memory 412 will have a data structure that associates these signatures with a location of user 202 within residence 201. This data structure will additionally associate the connected devices with the location of the user, thereby mapping the connected devices to the respective locations within residence 201. For example, signatures with data parameters of scale 213 outside the ideal data parameter range are associated with user 202 being inside bathroom 220. Signatures with data parameters of refrigerator 211 outside the ideal data parameter range are associated with user 202 being inside kitchen 224. Signatures with data parameters of client device 203 outside the ideal data parameter range are associated with user 202 being inside living room 226. Signatures with data parameters of security camera 205 outside the ideal data parameter range are associated with user 202 being inside bedroom 222.

Returning to FIG. 1, after the time and sensing parameters are recorded (S112), activity is predicted (S114). For example, as shown in FIG. 4, HNC 410 may predict an activity of user 202 based on known machine learning techniques. For example, presume that the time is 1:03 PM and user 202 is in living room 226 of residence 201 after returning from bathroom 220. Gateway device 210 will predict the activity of user 202 based on the current time, and on the history of user 202. If user 202 usually watches television on client device 203 from 12:30 PM to 1:30 PM, gateway device 210 will predict that user 202 will continue to watch television until 1:30.

Returning to FIG. 1, after activity is predicted (S114), it is determined whether the activity is periodic (S116). For example, with reference to FIG. 4, HNC 410 will access memory 412 and determine if the signature associated with user 202 has been generated before, and if it has been generated numerous times at the same time of day. This determination may be performed via any known machine learning algorithm.

Returning to FIG. 1, if it is determined that the activity is not periodic (N at S116), then the movement is recorded (S122). For example, presume that at 2:00 PM user 202 has moved within residence 201. In such a case, as shown in FIG. 4, HNC 410 will create a new signature based on the received wireless signals from the connected devices. HNC 410 will compare the new signature with those previously stored in memory 412. If the new signature does not match any signatures within memory 412, the signature will be recorded.

Returning to FIG. 1, after the movement is recorded, gateway device 210 will continue to receive communications from connected devices (return to S106). Then, client device 203, security camera 205, refrigerator 211 and scale 213 will continue to transmit respective wireless signals to gateway device 210. However, if it is determined that there is periodic movement (Y at S116).

For example, presume that at 2:30 PM user 202 has moved within residence 201, creating a new signature. In such a case, as shown in FIG. 4, HNC 410 will create a new signature based on the received wireless signals from the connected devices. HNC 410 will compare the new signature with those previously stored in memory 412. If the signature does match other signatures within memory 412, HNC 410 may determine whether there is any periodicity of the matching signatures, e.g., they occur at periodic intervals such as certain times of the day or week.

Returning to FIG. 1, after it is determined that there is periodic movement (Y at S116), then the closest connected device is found (S118). For example, returning to FIG. 4, HNC 410 will access the data structure within memory 412 that associates the rooms in residence 201 with the signatures and associates the respective connected devices with the rooms in residence 201. By determining the location of user 202 within residence 201, HNC 410 will therefore also determine the closest connected device to user 202.

Returning to FIG. 1, after the closest connected device is found (S118), the device is tagged based on the predicted activity (S120). For example, presume that user 202 has entered kitchen 224 at 2:30 PM. Gateway device 210 finds that this signature periodically appears in the signature data structure within memory 412; user 210 enters this area of residence 201 around 2:30 every day and remains here for three minutes before leaving. Gateway device 210 will then tag refrigerator 211, the connected device residing in kitchen 224, to kitchen 224.

Gateway device 210 is able to tag devices by finding patterns after a small period of time, a non-limiting example of which is a few days. Further, gateway device 210 is continuously learning by way of known artificial intelligence methods, non-limiting examples of which include neural networks and deep learning. As user 202 may add or remove devices from residence 201, gateway device 210 will constantly be refining the map of residence 201.

In some embodiments, user 202 can manually tag the connected devices by using gateway device 210. For example, with reference to FIG. 3B, User 202 may use GUI 408 on client device 203 to instruct controller 401 to tag the current location of user 202 as bathroom 220. Gateway device 210 will then associate signatures in that location with bathroom 220.

Returning to FIG. 1, after the device is tagged based on the predicted activity (S120), the movement is recorded (S122). Gateway device 210 will continue to receive monitored parameters from connected devices (Return to S106). For example, after gateway device 210 tags connected devices in residence 201, client device 203, security camera 205, refrigerator 211 and scale 213 will continue to send respective monitored parameters to gateway device 210.

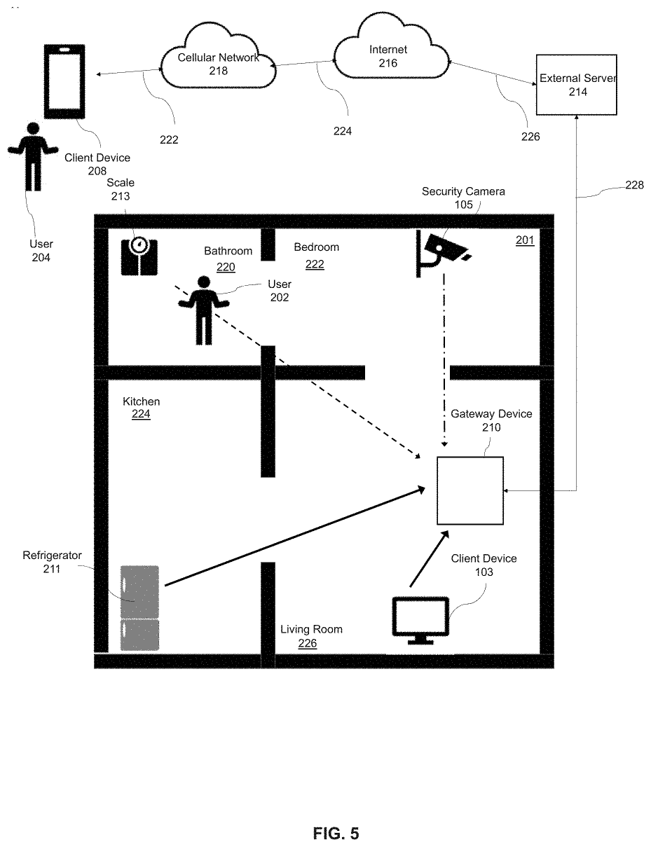

FIG. 5 shows an exploded view of residence 201 within communication network 200 at a time t₅, in accordance with aspects of the present disclosure, wherein if a caregiver of user 202 may be notified if user 202 does not follow a normal routine.

In addition to the contents of residence 201, FIG. 5 includes user 204, client device 208, external server 214, internet 216, cellular network 218, and communication channels 222, 224, 226, and 228.

In accordance with another aspect of the present disclosure, with reference to FIG. 5, presume that user 202 typically visits bathroom 220 in the early morning for about 10 minutes then visits kitchen 224. However, in this situation user has remained in bathroom 220 for two hours, for example user has fallen, is hurt and is unable to get up or call for help. Gateway device 210 analyzes signatures over the two hour time period. As shown in FIG. 4, HNC 410, recognizes that the periodic movement of user 202 determined with the signatures associated with visiting bathroom 220 in the early morning for about 10 minutes followed by signatures associated with visiting kitchen 224 did not occur. HNC 410 may then executed instructions in monitoring program 413 to therefore automatically instruct radio 414 of to transmit an update signal through communication channel 228 to radio 424 of external server 214. This signal will travel through communication channels 226, 224, and 222 to client device 208, operated by user 204. This update signal will alert user 204 of the abnormality of the activity of user 202.

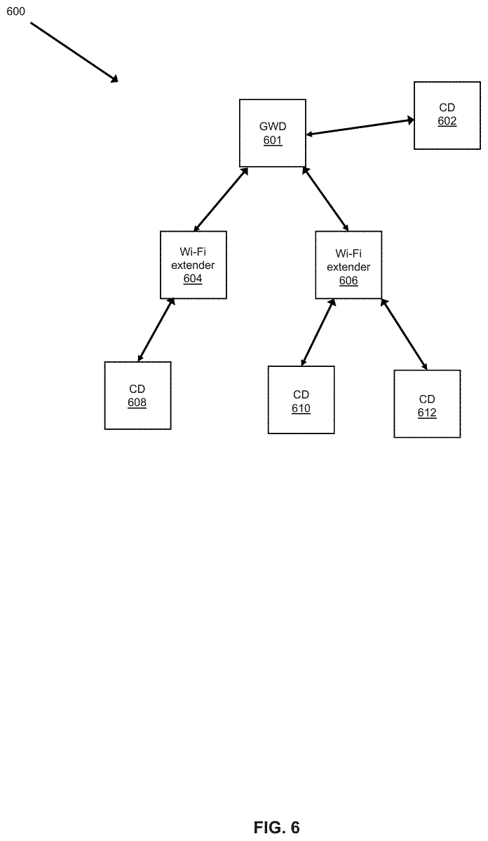

In accordance with another aspect of the present disclosure, a topology of the wireless network may be generated. This will be described in greater detail with reference to FIG. 6.

As shown in the figure, a topology of wireless network includes a gateway device 601, client devices 602, 608, 610, and 612, and Wi-Fi extenders 604 and 606. In this topology, client device 602 is directly connected to gateway device 601, and client devices 608, 610, and 612 are connected to gateway device 601 through Wi-Fi extenders 604 and 606. An HNC in accordance with the present disclosure may generate instructions to be transmitted to a client device to display a topology as shown in FIG. 6. In this manner, a user of the client device may easily see the topology of the network.

Still further, in accordance with another aspect of the present disclosure, controller 409 of gateway device 210 may be configured to execute instructions stored on memory 412 to create a map of residence 201, non-limiting examples of which include a bathroom, a bedroom, a kitchen, and a living room. Gateway device 210 will enable user 202 or user 204 to view a topology of residence 201 and the generated map of residence 201.

In households with Wi-Fi sensing technology, it is difficult to map the home and all of the devices within the home network. This can be difficult for an outside user to remotely observe what is happening within the household.

In accordance with aspects of the present disclosure, an HNC may reside within the home network's gateway device, which will collect data from the connected devices. As Wi-Fi signals are sensitive to objects and obstacles, mobile obstacles such as pets or people appearing between the gateway device and connected devices will reduce the respective signal strength. As such, the HNC may also both analyze respective device data and manage home network configuration changes. By analyzing respective device data, the HNC will be able to determine user activity as well as predict future user activity by monitoring changes in Wi-Fi signals. The HNC will also check for other environmental changes within the home network to adjust monitoring parameters. These features will create a map of the household. Optionally, a user may manually map the household. Additionally, an outside user will receive notifications when there appears to be abnormal activity within the household to help ensure the safety of individuals inside the household.

Thus, the present disclosure as disclosed will map the home and all devices within the home network through Wi-Fi sensing technology, and alert outside users when activity within the home network is abnormal.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A network controller for use with a person, a first network device, a second network device, an external network, and a client device, the first network device being configured to transmit first wireless signals, the second network device being configured to transmit second wireless signals, said network controller comprising:
a memory, having stored therein, a data structure associating the person with a first location and first a time of day and associating the person with a second location and a second time of day; and
a processor configured to execute instructions stored on said memory to cause said network controller to:
monitor the first wireless signals over a first period;
monitor the second wireless signals over a second period;
determine a change in one of the first wireless signals and the second wireless signals;
tag the first network device to the first location based on the determined change in the first wireless signals at the first time of day; and
tag the second network device to the second location based on the determined change in the second wireless signals at the second time of day.

2. The network controller of claim 1, wherein said processor is configured to execute instructions stored on said memory to additionally cause said network controller to create the data structure by:
monitoring the first wireless signals prior to the first period;
determining a previous number of changes in the first wireless signals monitored prior to the first period;
generating a first association of the first network device to the first location based on a first respective set of previous times of day for the determined previous number of changes in the first wireless signals monitored prior to the first period;
monitoring the second wireless signals prior to the second period;
determining a previous number of changes in the second wireless signals monitored prior to the second period;
generating a second association of the second network device to the second location based on a second respective previous times of day for the determined previous number of changes in the second wireless signals monitored prior to the second period; and
creating the data structure based on the generated first association and the generated second association.

3. The network controller of claim 1, wherein said processor is configured to execute instructions stored on said memory to additionally cause said network controller to determine the change in one of the first wireless signals and the second wireless signals based on at least one of the group consisting of: a change in a receive signal strength indicator value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

4. The network controller of claim 1, wherein said processor is configured to execute instructions stored on said memory to additionally cause said network controller to:
further monitor the first wireless signals;
further monitor the second wireless signals;
determine a change in one of the further monitored first wireless signals and the further monitored second wireless signals; and
automatically transmit an update signal to the client device based on one of a lack of change in the further monitored first wireless signals at the first time of day and a lack of change in the further monitored second wireless signals at the second time of day.

5. A method of using a network controller with a person, a first network device, a second network device, an external network, and a client device, the first network device being configured to transmit first wireless signals, the second network device being configured to transmit second wireless signals, said method comprising:
monitoring, via a processor configured to execute instructions stored on the memory having stored therein, a data structure associating the person with a first location and first a time of day and associating the person with a second location and a second time of day, the first wireless signals over a first period;
monitoring, via the processor, the second wireless signals over a second period;
determining, via the processor, a change in one of the first wireless signals and the second wireless signals;
tagging, via the processor, the first network device to the first location based on the determined change in the first wireless signals at the first time of day; and
tagging, via the processor, the second network device to the second location based on the determined change in the second wireless signals at the second time of day.

6. The method of claim 5, further comprising:
monitoring, via the processor, the first wireless signals prior to the first period;
determining, via the processor, a previous number of changes in the first wireless signals monitored prior to the first period;
generating, via the processor, a first association of the first network device to the first location based on a first respective set of previous times of day for the determined previous number of changes in the first wireless signals monitored prior to the first period;
monitoring, via the processor, the second wireless signals prior to the second period;
determining, via the processor, a previous number of changes in the second wireless signals monitored prior to the second period;
generating, via the processor, a second association of the second network device to the second location based on a second respective previous times of day for the determined previous number of changes in the second wireless signals monitored prior to the second period; and
creating, via the processor, the data structure based on the generated first association and the generated second association.

7. The method of claim 5, wherein said determining a change in one of the first wireless signals and the second wireless signals comprises determining the change in one of the first wireless signals and the second wireless signals based on at least one of the group consisting of: a change in a receive signal strength indicator value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

8. The method of claim 5, further comprising:
further monitoring, via the processor, the first wireless signals;
further monitoring, via the processor, the second wireless signals;
determining, via the processor, a change in one of the further monitored first wireless signals and the further monitored second wireless signals; and
automatically transmitting, via the processor, an update signal to the client device based on one of a lack of change in the further monitored first wireless signals at the first time of day and a lack of change in the further monitored second wireless signals at the second time of day.

9. A non-transitory, computer-readable media having computer-readable instructions stored thereon, the computer-readable instructions being capable of being read by a network controller for use with a person, a first network device, a second network device, an external network, and a client device, the first network device being configured to transmit first wireless signals, the second network device being configured to transmit second wireless signals, wherein the computer-readable instructions are capable of instructing the network controller to perform the method comprising:
monitoring, via a processor configured to execute instructions stored on the memory having stored therein, a data structure associating the person with a first location and first a time of day and associating the person with a second location and a second time of day, the first wireless signals over a first period;
monitoring, via the processor, the second wireless signals over a second period;
determining, via the processor, a change in one of the first wireless signals and the second wireless signals;
tagging, via the processor, the first network device to the first location based on the determined change in the first wireless signals at the first time of day; and
tagging, via the processor, the second network device to the second location based on the determined change in the second wireless signals at the second time of day.

10. The non-transitory, computer-readable media claim 9, wherein the computer-readable instructions are capable of instructing the external server to perform the method further comprising:
monitoring, via the processor, the first wireless signals monitored prior to the first period;
determining, via the processor, a previous number of changes in the first wireless signals monitored prior to the first period;
generating, via the processor, a first association of the first network device to the first location based on a first respective set of previous times of day for the determined previous number of changes in the first wireless signals monitored prior to the first period;
monitoring, via the processor, the second wireless signals monitored prior to the second period;
determining, via the processor, a previous number of changes in the second wireless signals monitored prior to the second period;
generating, via the processor, a second association of the second network device to the second location based on a second respective previous times of day for the determined previous number of changes in the second wireless signals monitored prior to the second period; and
creating, via the processor, the data structure based on the generated first association and the generated second association.

11. The non-transitory, computer-readable media claim 9, wherein the computer-readable instructions are capable of instructing the external server to perform the method wherein said determining a change in one of the first wireless signals and the second wireless signals comprises determining the change in one of the first wireless signals and the second wireless signals based on at least one of the group consisting of: a change in a receive signal strength indicator value of the one of the first wireless signals and the second wireless signals; a time stamp at which the one of the first wireless signals and the second wireless signals is received; a neighbor report within the one of the first wireless signals and the second wireless signals; a channel number of the one of the first wireless signals and the second wireless signals; a channel bandwidth of the one of the first wireless signals and the second wireless signals; a channel utilization of the one of the first wireless signals and the second wireless signals; a channel state information of the one of the first wireless signals and the second wireless signals; and combinations thereof.

12. The non-transitory, computer-readable media claim 9, wherein the computer-readable instructions are capable of instructing the external server to perform the method further comprising:
further monitoring, via the processor, the first wireless signals;
further monitoring, via the processor, the second wireless signals;
determining, via the processor, a change in one of the further monitored first wireless signals and the further monitored second wireless signals; and
automatically transmitting, via the processor, an update signal to the client device based on one of a lack of change in the further monitored first wireless signals at the first time of day and a lack of change in the further monitored second wireless signals at the second time of day.
